(19) United States
(12) Patent Application Publication
(10) Pub. No.: US 2026/0044062 A1
(43) Pub. Date: Feb. 12, 2026

(54) SPACE RENDERING APPARATUS AND SPACE RENDERING METHOD

(71) Applicant: Nippon Telegraph and Telephone Corporation, Tokyo (JP)

(72) Inventors: Takahiro MATSUMOTO, Musashino-shi, Tokyo (JP); Ayaka SANO, Musashino-shi, Tokyo (JP); Motohiro MAKIGUCHI, Musashino-shi, Tokyo (JP)

(21) Appl. No.: 19/099,599

(22) PCT Filed: Aug. 9, 2022
(86) PCT No.: PCT/JP2022/030435

§ 371 Date: Jan. 29, 2025

(51) Int. Cl. G03B 21/28; G03B 21/20

(52) U.S. Cl. CPC G03B 21/28; G03B 21/2073; G03B 21/2006

(57) ABSTRACT

A space production apparatus according to one aspect of the present invention includes a light source, a viewing angle limiting surface, and a mirror. The light source emits light for projecting a first image. The viewing angle limiting surface selectively reflects the light emitted from the light source toward a predetermined angular range, and is disposed such that an observer area where an observer is expected to be located is located in a direction outside the predetermined angular range. The first image is projected onto the viewing angle limiting surface. The mirror reflects the light emitted from the light source and reflected by the viewing angle limiting surface.

### TECHNICAL FIELD

The present invention relates to a space production apparatus and a space production method.

### BACKGROUND ART

Normally, an image of light reflected in a mirror is literally an image formed by specular reflection on the surface of the mirror. Therefore, to the human eye, the image when looking at real space reflected in a mirror and the image when looking at real space directly are perceived as identical mirror images.

Furthermore, since mirrors are widely used in daily life, what kind of image is reflected in a mirror can often be easily predicted by people who are used to looking at mirrors in their daily lives.

NPL 1 discloses a method of displaying an image that does not exist in real space in a mirror. The method disclosed in NPL 1 uses a half mirror and a light-emitting diode (LED) display in combination, and the LED display is physically installed behind the half mirror. In the part where the LED does not emit light, the half mirror reflects the light in real space to create an image, and in the part where the LED emits light, the LED light passes through the half mirror to create an image on the half mirror. Therefore, when viewed from a person standing in front of the half mirror, an image that does not exist in real space is displayed on the half mirror.

However, since it is necessary to install a relatively heavy LED display in a space behind the mirror, the method disclosed in NPL 1 is difficult to implement in cases where the LED display cannot be placed due to spatial constraints.

### CITATION LIST

### Non Patent Literature

[NPL 1] Uchida Hiroki, Ebihara Tadashi, Wakatsuki Naoto, Zempo Keiichi, “ALISE: Through the Mirrored Space, and What User Interacts with Avatars Naturally,” Association for Computing Machinery, 2021, p. 29-32.

### SUMMARY OF INVENTION

### Technical Problem

An object of the present invention is to provide a space production technique that presents different images to an observer in a real space and a mirror image space (a real space reflected in a mirror).

### Solution to Problem

A space production apparatus according to one aspect of the present invention includes a light source, a viewing angle limiting surface, and a mirror. The light source emits light for projecting a first image. The viewing angle limiting surface selectively reflects the light emitted from the light source toward a predetermined angular range, and is disposed such that an observer area where an observer is expected to be located is located in a direction outside the predetermined angular range. The first image is projected onto the viewing angle limiting surface. The mirror reflects the light emitted from the light source and reflected by the viewing angle limiting surface.

### ADVANTAGEOUS EFFECTS OF INVENTION

According to the present invention, it is possible to provide a space production technique that presents different visual information to an observer in a real space and a mirror image space.

### BRIEF DESCRIPTION OF DRAWINGS

FIG. 1 is a diagram showing an example of a configuration of a space production apparatus according to a first embodiment.

FIG. 2 is a diagram illustrating reflection characteristics of a viewing angle limiting surface shown in FIG. 1.

FIG. 3 is a diagram showing an image presented using a light source shown in FIG. 1.

FIG. 4 is a diagram showing an image seen from an observer area according to the first embodiment.

FIG. 5 is a diagram showing another example of the configuration of the space production apparatus according to the first embodiment.

FIG. 6 is a diagram illustrating reflection characteristics of a viewing angle limiting surface shown in FIG. 5.

FIG. 7 is a diagram showing a configuration of a space production apparatus according to a second embodiment.

FIG. 8 is a diagram showing an image presented using a display device shown in FIG. 7.

FIG. 9 is a diagram showing an image presented using a polarized light source shown in FIG. 7.

FIG. 10 is a diagram showing an image seen by an observer according to the second embodiment.

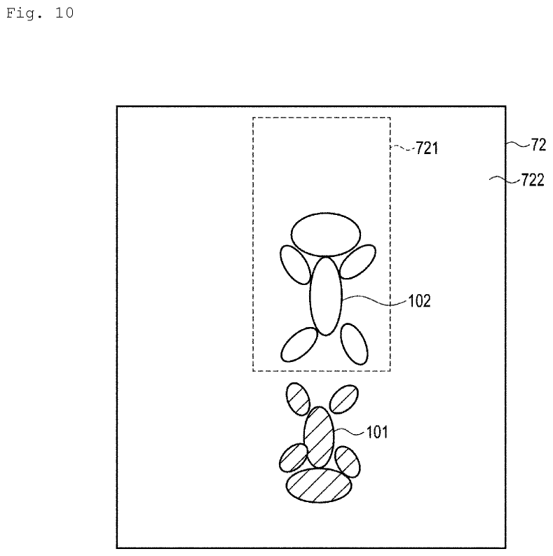

### DESCRIPTION OF EMBODIMENTS

Embodiments of the present invention will be described below with reference to the drawings.

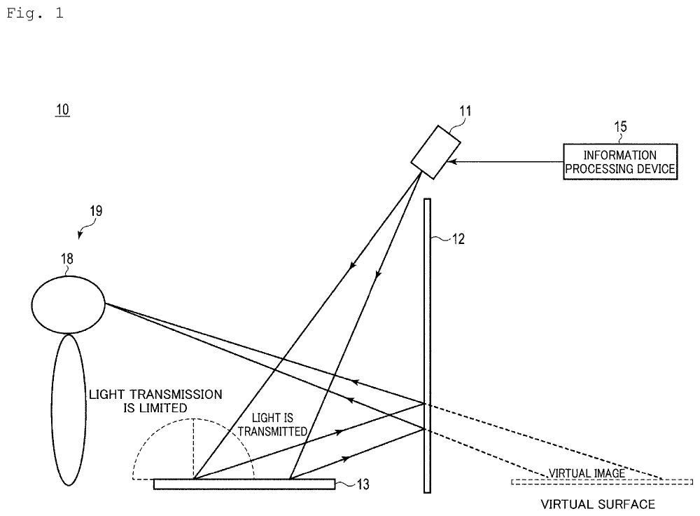

FIG. 1 schematically shows a space production apparatus 10 according to a first embodiment. As shown in FIG. 1, the space production apparatus 10 includes a light source 11, a mirror 12, a viewing angle limiting surface 13, and an information processing device 15.

The information processing device 15 is communicatively connected to the light source 11 and controls the light source 11. The connection between the information processing device and the light source 11 may be a wired connection or a wireless connection. For example, the information processing device 15 controls the light source 11 to project an image as visual information. Specifically, the information processing device 15 transmits image data of an image to be projected onto the light source 11. Visual information refers to information that is recognized by people through their sense of sight. The image may be a still image or a moving image (video). The information processing device 15 may be a computer such as a personal computer (PC).

The light source 11 emits light for projecting an image. The light source 11 is disposed at a position where it can project light onto the viewing angle limiting surface 13, and an image is projected onto the viewing angle limiting surface 13. For example, the light source 11 receives image data from the information processing device 15 and emits light beams toward the viewing angle limiting surface 13 according to the received image data. As the light source 11, for example, a light projector such as a projector can be used. A projector is an optical device that projects an image onto a surface such as a screen. Hereinafter, the light emitted from the light source 11 may be referred to as visual information light.

Note that the information processing device 15 may be omitted from the space production apparatus 10. For example, the functions of the information processing device 15 may be implemented by a computer built into the light source 11, such as a microcomputer. In this case, the image data may be provided to the light source 11 while being stored in a recording medium such as a USB memory.

The mirror 12 specularly reflects light. The mirror 12 may be, for example, a general plane mirror with a planar reflective surface. The mirror 12 is placed upright facing an observer area 19 where an observer 18 is expected to be located.

The viewing angle limiting surface 13 selectively diffuses and reflects incident light toward a predetermined angular range. The viewing angle limiting surface 13 may be, for example, a light projection surface covered with a viewing angle limiting film. A viewing angle limiting film refers to an optical film that has the property of transmitting light in a specific angular range. Specifically, the viewing angle limiting film is an optical film that transmits light traveling in a direction within a specific angular range and blocks light traveling in a direction outside the specific angular range.

Viewing angle limiting films are used for purposes such as protecting privacy by attaching them to window glass. The light projection surface is a physical surface (for example, a physical plane) that diffusely reflects light, and refers to a physical surface on which projector light can be projected. As the light projection surface, for example, a white wall or floor or a screen can be used. In the present embodiment, the viewing angle limiting surface 13 includes a screen and a viewing angle limiting film attached to the screen. In an example where the light projection surface is a white wall or floor, the viewing angle limiting surface 13 includes a viewing angle limiting film attached to the white wall or floor.

The viewing angle limiting surface 13 is disposed between the observer area 19 and the mirror 12 such that the mirror 12 is located in a direction within an angular range that reflects light and the observer area 19 is located in a direction outside the angular range that reflects light. The viewing angle limiting film of the viewing angle limiting surface 13 limits the transmission of the visual information light diffusely reflected by the screen of the viewing angle limiting surface 13 in the direction of the observer area 19. Therefore, the visual information light is not diffused in the direction of the observer 18.

The mirror 12 and the viewing angle limiting surface 13 may be disposed such that the observer 18 located in the observer area 19 can see the viewing angle limiting surface 13 through the mirror 12. In the example shown in FIG. 1, the light source 11 is placed on the ceiling, and the viewing angle limiting surface 13 is placed on the floor. In other examples, the light source 11 may be supported by a tripod and the viewing angle limiting surface 13 may be placed on a wall.

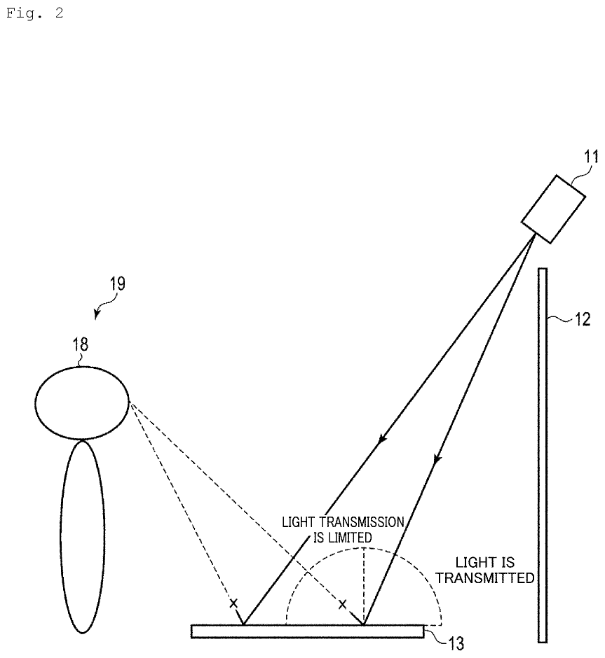

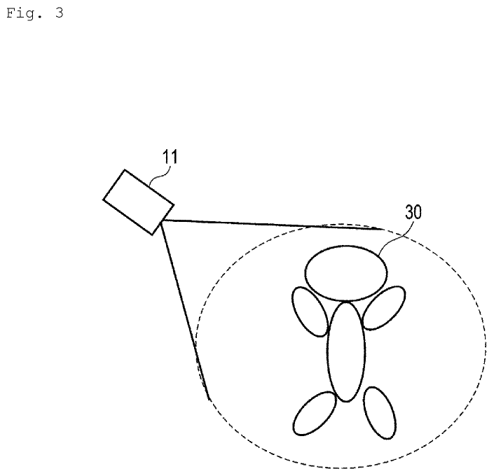

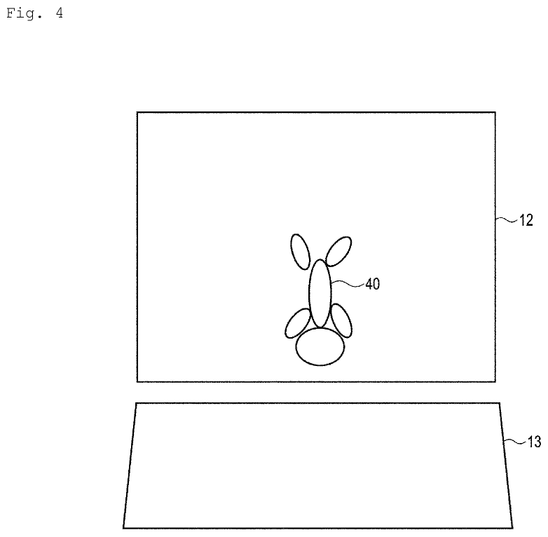

When the light source 11 emits visual information light toward the viewing angle limiting surface 13, the light is reflected in the direction of the mirror 12, and the observer 18 sees a virtual image behind the mirror 12. On the other hand, as shown in FIG. 2, since the visual information light is not diffused in the direction of the observer 18 by the viewing angle limiting surface 13, the observer 18 cannot see the real image reflected on the viewing angle limiting surface 13. For example, when the light source 11 projects a humanoid image 30 shown in FIG. 3 onto the viewing angle limiting surface 13, as shown in FIG. 4, the observer 18 cannot visually recognize the real image on the viewing angle limiting surface 13, but can visually recognize a virtual image 40 thereof on the mirror 12. That is, the space production apparatus 10 can create a state in which an image is not reflected on the viewing angle limiting surface 13 but is reflected on the mirror 12 when viewed from the observer area 19.

As described above, in the space production apparatus 10, the light source 11 emits visual information light corresponding to the image data received from the information processing device 15 toward the viewing angle limiting surface 13. The visual information light from the light source 11 is directly incident on the viewing angle limiting surface 13. The viewing angle limiting surface 13 selectively reflects visual information light from the light source 11 toward a predetermined angular range. The viewing angle limiting surface 13 is disposed such that the observer area 19 is located in a direction outside the predetermined angular range. This prevents the visual information light reflected by the viewing angle limiting surface 13 from going directly to the observer area 19. The mirror 12 is located in a direction within the predetermined angular range, and specularly reflects the visual information light reflected by the viewing angle limiting surface 13. The visual information light from the light source 11 is reflected by the viewing angle limiting surface 13, and the visual information light reflected by the viewing angle limiting surface 13 is reflected by the mirror 12 and reaches the observer 18. Therefore, the space production apparatus 10 can create a state in which the observer 18 cannot visually recognize the image in the real space (specifically, viewing angle limiting surface 13), but can visually recognize the image reflected in the mirror (specifically, the mirror 12). That is, the space production apparatus 10 can present different images to the observer 18 in the real space and the mirror image space (the real space reflected in the mirror). As a result, it is possible to give the observer 18 an unexpected surprise.

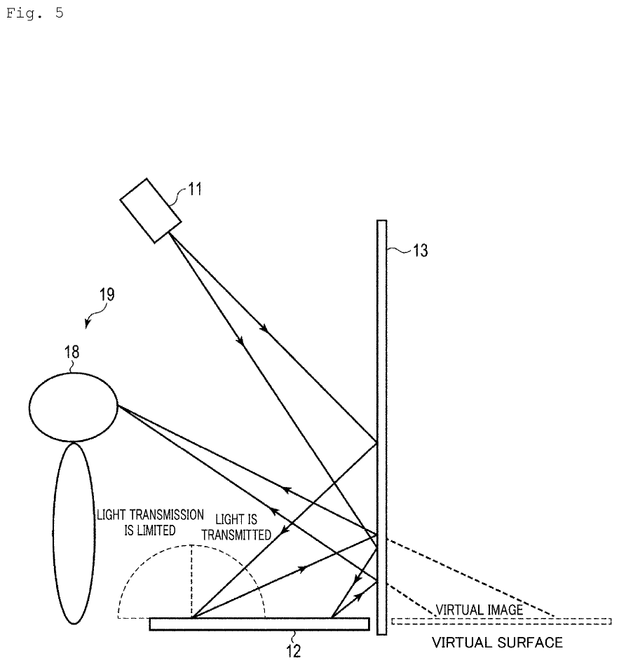

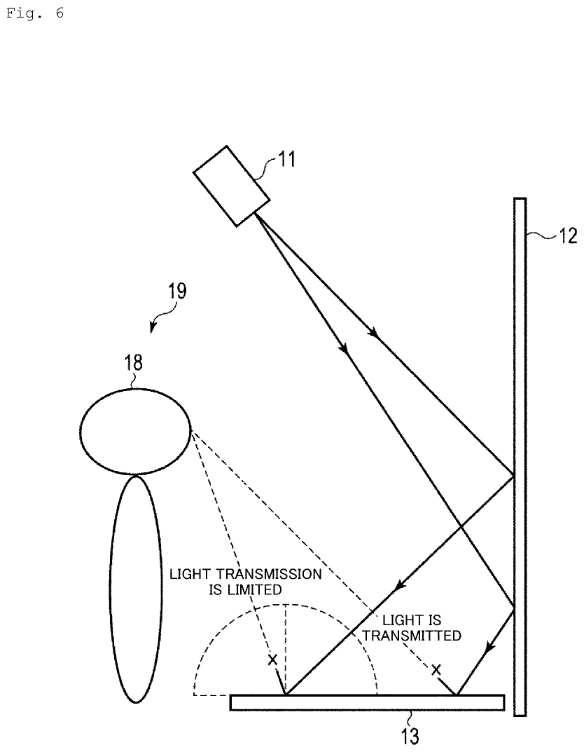

In the above example, the visual information light from the light source 11 is directly incident on the viewing angle limiting surface 13. Alternatively, the light source 11, the mirror 12, and the viewing angle limiting surface 13 may be disposed such that the visual information light is incident on the viewing angle limiting surface 13 via the mirror 12, as shown in FIG. 5. In the disposition shown in FIG. 5, the light source 11 emits visual information light toward the mirror 12, and the visual information light is reflected by the mirror 12 and reaches the viewing angle limiting surface 13. Thus, a real image is created on the screen of the viewing angle limiting surface 13. In this case as well, as shown in FIG. 6, since light is not diffused in the direction of the observer 18 by the viewing angle limiting surface 13, the observer cannot see the real image on the viewing angle limiting surface 13. Therefore, in the configuration shown in FIG. 5 as well, different visual information can be presented to the observer 18 in the real space and the mirror image space.

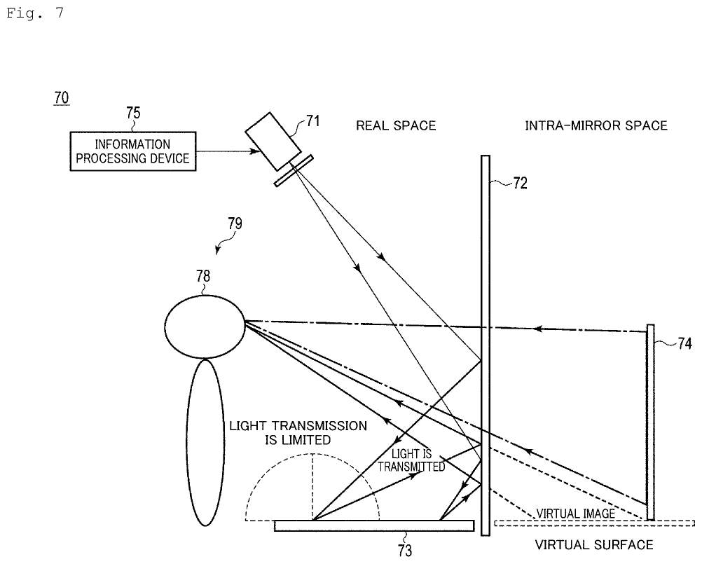

FIG. 7 schematically shows a space production apparatus 70 according to a second embodiment. As shown in FIG. 7, the space production apparatus 70 includes a polarized light source 71, a polarizing mirror 72, a viewing angle limiting surface 73, a display device 74, and an information processing device 75. Since the viewing angle limiting surface 73 is the same as the viewing angle limiting surface 13 according to the first embodiment, the description of the viewing angle limiting surface 73 will be omitted as appropriate.

The information processing device 75 is communicatively connected to the polarized light source 71 and the display device 74, and controls the polarized light source 71 and the display device 74. The connection between the information processing device 75 and the polarized light source 71 may be a wired connection or a wireless connection. The connection between the information processing device 75 and the display device 74 may be a wired connection or a wireless connection. For example, the information processing device 75 controls the polarized light source 71 to project an image onto the viewing angle limiting surface 73. Specifically, the information processing device 75 transmits image data of an image to be projected onto the viewing angle limiting surface 73 to the polarized light source 71. Furthermore, the information processing device 75 controls the display device 74 to display images. Specifically, the information processing device 75 transmits data of an image to be displayed on the display device 74 to the display device 74. The information processing device 75 may be a computer such as a PC.

The polarized light source 71 is a light source that emits linearly polarized light. The polarized light source 71 can be realized, for example, by a combination of a non-polarized light source and a linear polarizer. A non-polarized light source is a light source that emits non-polarized light. A light projector such as a projector can be used as the non-polarized light source. The non-polarized light source may be, for example, the same light source as the light source 11 (FIG. 1) according to the first embodiment. A linear polarizer is an optical filter that passes light of a specific polarization but blocks light of other polarizations. As the linear polarizer, for example, a linear polarizing film can be used. Linearly polarized light is obtained by passing light from a non-polarized light source through a linear polarizer. The polarized light source 71 receives image data from the information processing device 75 and emits a linearly polarized light beam toward the viewing angle limiting surface 73 according to the received image data.

The polarizing mirror 72 selectively transmits light that is linearly polarized in one direction in the vertical and horizontal directions, and reflects light that is linearly polarized in the other direction in the vertical and horizontal directions. As a mirror having optical characteristics corresponding to the polarizing mirror 72, a reflective polarizer such as a wire grid polarizer is known. As the polarizing mirror 72, a beam splitter plate made of a reflective polarizer can be used. Most of the light that exists in our living spaces is unpolarized and is composed of light that has both vertical and horizontal polarization components. A polarizing mirror transmits one of the vertical and horizontal components included in unpolarized light and reflects the other. For this reason, a polarizing mirror placed in a living space is considered as a half mirror, and can reflect the surrounding environment like a mirror.

The polarizing mirror 72 is placed upright facing an observer area 79 where an observer 78 is expected to be located. In the following, to simplify the description, when the space is divided into two by the polarizing mirror 72, the space on the side where the observer 78 is present is called a real space, and the space behind the polarizing mirror 72 as seen from the observer 78 is called an intra-mirror space.

The polarized light source 71 irradiates the polarizing mirror 72 with visual information light that is linearly polarized in the polarization direction reflected by the polarizing mirror 72. Therefore, the polarizing mirror 72 reflects the linearly polarized visual information light from the polarized light source 71. The visual information light from the polarized light source 71 is incident on the viewing angle limiting surface 73 via the polarizing mirror 72.

The viewing angle limiting surface 73 includes a screen and a viewing angle limiting film attached to the screen. The viewing angle limiting surface 73 is disposed between the observer area 79 and the polarizing mirror 72 such that the polarizing mirror 72 is located in a direction within an angular range that reflects light and the observer area 79 is located in a direction outside the angular range that reflects light. The viewing angle limiting film limits the transmission of the visual information light diffusely reflected by the screen in the direction of the observer area 79. Therefore, the visual information light is not diffused in the direction of the observer 78.

The polarizing mirror 72 and the viewing angle limiting surface 73 may be disposed such that the observer 78 located in the observer area 79 can see the viewing angle limiting surface 73 through the polarizing mirror 72.

When the polarized light source 71 emits visual information light, similarly to what was described in the first embodiment, the observer 78 can see a virtual image behind the polarizing mirror 72, but cannot see the real image reflected on the viewing angle limiting surface 73.

The display device 74 displays an image. The display device 74 may be, for example, an LED display. The display device 74 is disposed in the intra-mirror space. Specifically, the display device 74 is disposed to face the observer 78 via the polarizing mirror 72. The display surface of the display device 74 may be parallel to the polarizing mirror 72. Since the polarizing mirror 72 has characteristics as a half mirror, the light of the image displayed on the display device 74 passes through the polarizing mirror 72 and reaches the observer area 79. Therefore, to the observer 78, the image appears to be reflected in a mirror (polarizing mirror 72), although it does not exist in real space.

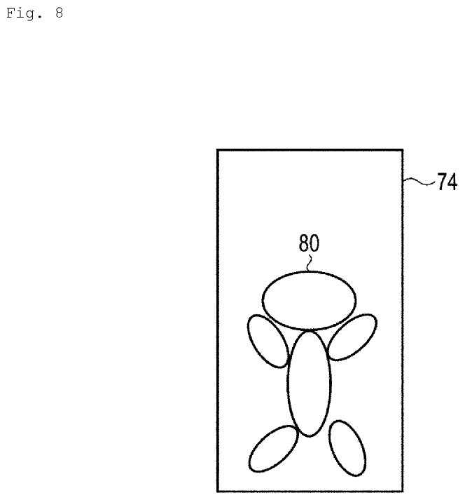

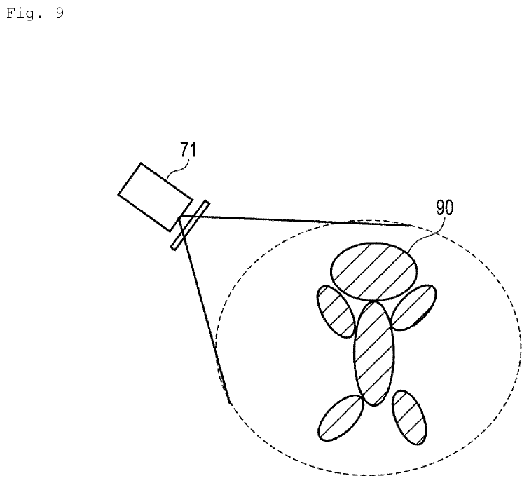

Typically, the image presented using the display device 74 is different from the image presented using the polarized light source 71. For example, a humanoid avatar 80 is displayed on the display device 74 as shown in FIG. 8, and a shadow 90 of the avatar 80 is projected using the polarized light source 71 as shown in FIG. 9. In this case, when viewed from the observer area 79, an image 102 corresponding to the avatar 80 and an image 101 corresponding to the shadow 90 are reflected on the polarizing mirror 72. That is, an avatar and its shadow can be created in the mirror (polarizing mirror 72). By using the polarized light source 71, an image can also be created in a portion 722 of the polarizing mirror 72 other than a portion 721 facing the display device 74.

As described above, in the space production apparatus 70, the polarized light source 71 emits visual information light corresponding to the image data received from the information processing device 75 toward the polarizing mirror 72. In an example in which the polarizing mirror 72 is configured to selectively reflect vertically linearly polarized light, the polarized light source 71 is provided such that the vertically linearly polarized visual information light is incident on the polarizing mirror 72. Thereby, the visual information light from the polarized light source 71 is reflected by the polarizing mirror 72 and directed toward the viewing angle limiting surface 73. The viewing angle limiting surface 73 selectively reflects light toward a predetermined angular range. The viewing angle limiting surface 73 is disposed such that the observer area 79 is located in a direction outside the predetermined angular range. This prevents the visual information light reflected by the viewing angle limiting surface 73 from going directly to the observer area 79. The polarizing mirror 72 is located in a direction within the predetermined angular range, and reflects the visual information light reflected by the viewing angle limiting surface 73 toward the observer area 79. Furthermore, a portion of the light of the image displayed on the display device 74 passes through the polarizing mirror 72 and reaches the observer area 79. Therefore, the space production apparatus 70 can create a state in which the observer 78 cannot visually recognize the image in the real space, but can visually recognize the image reflected in the mirror (specifically, the polarizing mirror 72). That is, the space production apparatus 70 can present different images to the observer 78 in the real space and the mirror image space.

Note that the present invention is not limited to the embodiments described above and can variously be modified at an execution stage within a scope not departing from the gist of the present invention. In addition, the embodiments may be combined as appropriate, and in such a case, combined effects can be achieved. Furthermore, the above embodiments include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

10 Space production apparatus
11 Light source
12 Mirror
13 Viewing angle limiting surface
15 Information processing device
70 Space production apparatus
71 Polarized light source
72 Polarizing mirror
73 Viewing angle limiting surface
74 Display device
75 Information processing device

1. A space production apparatus comprising:
a light source configured to emit light for projecting a first image;
a viewing angle limiting surface configured to selectively reflect the light emitted from the light source toward a predetermined angular range, the viewing angle limiting surface being disposed such that an observer area where an observer is expected to be located is located in a direction outside the predetermined angular range, and onto which the first image is projected; and
a mirror configured to reflect the light emitted from the light source and reflected by the viewing angle limiting surface.

2. The space production apparatus according to claim 1, wherein the light emitted from the light source is directly incident on the viewing angle limiting surface.

3. The space production apparatus according to claim 1, wherein the light emitted from the light source is incident on the viewing angle limiting surface via the mirror.

4. The space production apparatus according to claim 1, further comprising:
a display device that is disposed opposite to the observer area via the mirror and configured to display a second image,
wherein the light source is configured to emit the light polarized in a first direction, and the mirror is a polarizing mirror configured to reflect the light polarized in the first direction and transmit the light polarized in a second direction orthogonal to the first direction.

5. The space production apparatus according to claim 1, wherein the viewing angle limiting surface includes an optical film attached to a physical surface configured to diffusely reflect light, the optical film is configured to transmit light diffusely reflected by the physical surface to travel in a direction within the predetermined angular range, and block light diffusely reflected by the physical surface to travel in a direction outside the predetermined angular range.

6. A space production method comprising:
controlling a light source that emits light for projecting a first image;
providing a viewing angle limiting surface that selectively reflects the light emitted from the light source toward a predetermined angular range, the viewing angle limiting surface being disposed such that an observer area where an observer is expected to be located is located in a direction outside the predetermined angular range, and onto which the first image is projected; and
providing a mirror that reflects the light emitted from the light source and reflected by the viewing angle limiting surface.
